(19) United States
(12) Patent Application Publication
(10) Pub. No.: US 2026/0162106 A1
(43) Pub. Date: Jun. 11, 2026

(54) CONFIGURATION-BASED REAL-TIME NOTIFICATIONS IN TRANSACTION SYSTEMS

(71) Applicant: Truist Bank, Charlotte, NC (US)

(72) Inventors: Kendra Henry, Charlotte, NC (US); Luana Peterman, Lancaster, SC (US)

(73) Assignee: Truist Bank, Charlotte, NC (US)

(21) Appl. No.: 19/463,372

(22) Filed: Jan. 29, 2026

Related U.S. Application Data
(63) Continuation of application No. 18/107,828, filed on Feb. 9, 2023, now Pat. No. 12,561,680.

(51) Int. Cl. G06Q 20/38

(52) U.S. Cl. CPC G06Q 20/389; G06Q 20/386

(57) ABSTRACT

A system can, using reduced memory resources, receive by a notification computing system, an alert issued by a server application of a server associated with a transaction channel of a transaction computing system regarding a problem associated with the transaction channel. The notification computing system can use information contained in the alert, such as an identification of the transaction channel associated with the alert, an alert type, and an alert severity, to determine a form of a notification to be generated, the content of the notification, and at least one recipient of the notification. From at least the alert severity, the system can also determine that at least a partial shutdown of the transaction computing system is required. The notification computing system can subsequently generate and transmit the notification to the at least one recipient, and initiate at least a partial shutdown of the transaction computing system.

### CROSS-REFERENCE TO RELATED APPLICATIONS

The present is a continuation of U.S. patent application Ser. No. 18/107,828, filed Feb. 9, 2023, titled “CONFIGURATION-BASED REAL-TIME NOTIFICATIONS IN TRANSACTION SYSTEMS,” the entirety of which is incorporated herein by reference.

### TECHNICAL FIELD

The present disclosure relates generally to real-time monitoring and alerting, and more particularly, although not exclusively, to automatic and real-time alerting of problems associated with electronic transaction channels.

### BACKGROUND

Electronic transactions associated with a given entity may take place across multiple transaction channels. These transaction channels may be monitored so as to detect problems related to transmission or processing of electronic transactions associated therewith. In at least some circumstances, it is desirable to indicate a problem associated with a transaction channel and to remediate the problem as quickly as possible. Likewise, it is desirable to ensure that a party to which a problem is indicated is an appropriate party according to the nature of the problem and the transaction channel where the problem occurred.

Because multiple channel electronic transaction systems may monitor a large volume of transactions, the process of identifying, indicating and remediating problems associated with given transaction channels is commonly tedious and slow, and can consume significant memory and other resources. For example, a typical process of identifying, indicating and remediating problems associated with given transaction channels can involve writing information associated with each problem to a log, which a user must then subsequently access in an attempt to identify each problem and to determine what party or parties should be notified relative to each problem. Identification and notification of transaction channel problems on a problem-by-problem basis is not only time-ATTORNEY consuming, but also requires significant memory resources to store all the information regarding a potential multitude of problems that may occur across the multiple transaction channels.

### SUMMARY

According to one example of the present disclosure, a system may include a transaction computing system. The transaction computing system may include at least one web server configured to establish a secure data exchange with remote user devices and to receive transaction requests from the remote user devices, and a plurality of application servers, each application server including a server processor and a memory communicatively coupled to the server processor, the memory storing a server application including instructions that are executable by the server processor to cause the server application to perform operations. For example, the server application may execute transaction requests that are received by the web server from the remote user devices via a plurality of transaction channels and subsequently forwarded to the application server, and generate an alert when one of the plurality of transaction-channels uniquely associated with the application server experiences a problem that affects operation of the transaction channel, and where the alert indicates an alert severity. The system may also include a notification computing system that is communicatively coupled to the transaction computing system. The notification computing system may include an events queue to temporarily store alerts generated by the server applications of the transaction computing system application servers, and a processor and a memory communicatively coupled to the processor, the memory including instructions that are executable by the processor to cause the notification computing system to perform operations. For example, the notification computing system may monitor the transaction requests received by the transaction computing system, and receive, in real time from one or more of the server applications of the application servers of the transaction computing system, one or more alerts generated by the one or more server applications. The notification computing system may also temporarily store the one or more alerts in the events queue, and determine, based on at least the alert severity of a given alert of the one or more alerts temporarily stored in the events queue, a need to at least partially shut down the transaction computing system. The notification computing system may additionally generate a unique notification for the given alert, wherein a form of the notification is based on the alert severity, at least one recipient of the notification is determined based at least in part on the alert type, and a content of the notification informs the at least one recipient of the need to at least partially shut down the transaction computing system. The notification computing system may further transmit the notification in real time to the at least one recipient of the notification, and initiate at least a partial shutdown of the transaction computing system.

According to another example of the present disclosure, a non-transitory computer readable medium may include a first non-transitory computer-readable medium comprising instructions that are executable by an application server processor of an application server of a plurality of application servers of a transaction computing system for causing the server processor to perform operations. For example, the server processor may execute, by a server application of the server, transaction requests that are received by a web server through a secure data exchange with remote user devices via a plurality of transaction channels and subsequently forwarded to the application server. The server processor may also generate, by the server application, an alert when one of the plurality of transaction channels uniquely associated with the application server experiences a problem that affects operation of the transaction channel, where the alert indicates an alert severity. The non-transitory computer readable medium may also include a second non-transitory computer-readable medium comprising instructions that are executable by a processor of a notification computing system communicatively coupled to the transaction computing system via a network and comprising an events queue to temporarily store alerts generated by the server applications of the transaction computing system application servers, the instructions configured for causing the notification computing system to perform operations. For example, the notification computing system may monitor the transaction requests received by the transaction computing system, and receive, in real time from one or more of the server applications of the application servers of the transaction computing system, one or more alerts generated by the one or more server applications. The notification computing system may also temporarily store the one or more alerts in the events queue, and determine, based on at least the alert severity of a given alert of the one or more alerts temporarily stored in the events queue, a need to at least partially shut down the transaction computing system. The notification computing system may additionally generate a unique notification for the given alert, wherein a form of the notification is based on the alert severity, at least one recipient of the notification is determined based at least in part on the alert type, and a content of the notification informs the at least one recipient of the need to at least partially shut down the transaction computing system. The notification computing system may further transmit the notification in real-time to the at least one recipient of the notification, and initiate at least a partial shut down of the transaction computing system.

According to a further example of the present disclosure, a computer-implemented method may include, at a transaction computing system including at least one web server configured to establish a secure data exchange with remote user devices and to receive transaction requests from the remote user devices, and a plurality of application servers, where each application server includes a server processor and a memory communicatively coupled to the server processor, the memory storing instructions that are executable by the server processor to cause the server processor to perform operations including executing transaction requests received by the web server from the remote user devices via a plurality of transaction channels and subsequently forwarded to the application server. The operations of the server processor may also include generating an alert when one of the plurality of transaction channels uniquely associated with the application server experiences a problem that affects operation of the transaction channel, where the alert indicates an alert severity. The method additionally includes, at a notification computing system communicatively coupled to the transaction computing system via a network and comprising an events queue to temporarily store alerts generated by the server applications of the transaction computing system application servers, a processor, and a memory communicatively coupled to the processor and including instructions that are executable by the processor to cause the notification computing system to perform operations, monitoring the transaction requests received by the transaction computing system. The method also includes, using the notification computing system to receive, in real time from one or more of the server applications of the application servers of the transaction computing system, one or more alerts generated by the one or more server applications, temporarily store the one or more alerts in the events queue, and determine, based on at least the alert severity of a given alert of the one or more alerts temporarily stored in the events queue, a need to at least partially shut down the transaction computing system. According to the method, the notification computing system also generates a unique notification for the given alert, wherein a form of the notification is based on the alert severity, at least one recipient of the notification is determined based at least in part on the alert type, and a content of the notification informs the at least one recipient of the need to at least partially shut down the transaction computing system, transmits the notification in real time to the at least one recipient of the notification, and initiates at least a partial shutdown of the transaction computing system.

### BRIEF DESCRIPTION OF THE DRAWINGS

FIG. 1 is a schematic diagram representing one example of a computing environment within which electronic transactions can take place.

FIG. 2 is a block diagram of a system for notifying at least one recipient in real time about an alert issued by a transaction channel of a transaction system, according to an example of the present disclosure.

FIG. 3 is a block diagram of a system for notifying at least one recipient in real time about an alert issued by a transaction channel of a transaction system according to another example of the present disclosure.

FIG. 4 is a flowchart of a computerized method of notifying at least one recipient in real time about an alert issued by a transaction channel of a transaction system, according to one example of the present disclosure.

### DETAILED DESCRIPTION

An electronic transaction computing environment may include a transaction system having multiple different transaction channels through which users can transmit transaction requests to an entity for processing. Transaction systems may be complex, having multiple components and applications that can reside at different locations and depend on expected operations and interactions for proper transaction processing. As a result of such complexities, and in light of the substantial number of transactions that are commonly processed by a given entity, a transaction system can experience problems such as but not limited to, component and application malfunctions, or incomplete or corrupted transaction data, associated with the various transaction channels of the system.

Aspects of the present disclosure are directed to a system for automatically notifying one or more appropriate parties to the existence of an alert generated in response to a problem associated with a transaction channel. The transaction channel associated with a given alert may be one of a plurality of transaction channels via which transactions are received and processed by a given entity.

A notification system according to the present disclosure may include multiple layers for monitoring multiple transaction channels for alerts and associated problems, and for notifying one or more appropriate parties to the existence of an alert generated in response to a problem associated with a transaction channel. For example, a transaction channel monitoring layer may be operative to monitor a plurality of transaction channels and to receive an alert generated by a server application of a server associated with a transaction channel when a problem occurs relative to the transaction channel. Additionally, a real-time notification layer can retrieve alerts received by the channel monitoring layer regarding problems associated with individual transaction channels of the plurality of transaction channels. Based on information in the alerts, such as but not limited to, an identification of the transaction channel that issued the alert, the alert type, and the alert severity, the real-time notification layer can automatically determine a type of notification that should be generated and to whom the notification should be transmitted, and can then automatically generate a proper notification and transmit the notification to an appropriate recipient(s).

Thus, a notification system of the present disclosure can automatically generate a notification associated with a given transaction channel problem, and can further transmit the notification or incident report in real-time to an appropriate recipient(s) without any required user input. This saves both time and memory resources, and the real-time nature of the notification may also help to minimize any negative consequences of a transaction channel problem.

The following illustrative examples are provided to introduce the reader to the general subject matter discussed herein, and are not intended to limit the scope of the disclosed concepts. In the following description, specific details are set forth in order to provide a thorough understanding of various implementations and examples. Various implementations may be practiced without these specific details. The figures and description are not intended to be restrictive.

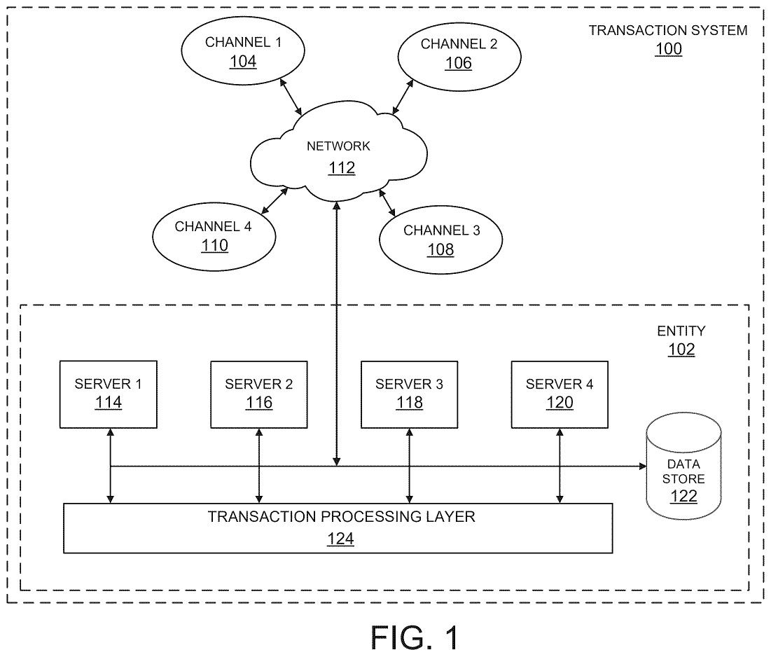

FIG. 1 is a schematic diagram representing an example of a computing environment including a transaction system 100 via which users can transmit transaction requests to an entity 102 for processing. The transaction system 100 can include one or more transaction channels, with four transaction channels 104, 106, 108, 110 being present in this example. The transaction channels 104-110 can communicate with other components and layers of the transaction system 100 at the entity 102 via a network 112. The network may be without limitation, a local area network (LAN), a wide-area network (WAN) such as the Internet, an institutional network, cellular or other wireless networks, virtual networks such as an intranet or an extranet, etc.

The transaction channels 104-110 of the transaction system 100 can include, for example and without limitation, payment channels, fund transfer channels, loan servicing channels, account services channels, ATM channels, mobile device transaction channels, etc. While only four transaction channels 104-110 are shown to be part of the transaction system 100 in the example of FIG. 1, other transaction system examples may include a lesser or a greater number of transaction channels. Also, while the transaction channels 104-110 are all shown to be located remotely from the entity 102 in the example of FIG. 1, it is possible that a given transaction system may also include internal transaction channels.

Various components and layers of the transaction system 100 may be located at the entity 102. In the computing environment and transaction system example of FIG. 1, the components are shown to include a plurality of computing devices in the form of servers 114, 116, 118, 120. Each of the servers 114-120 interacts with a corresponding transaction channel 104-110, and supports the transaction processing operation.

The servers 114-120 may be various types of servers. For example, one or more of the servers 114-120 can be an application server that includes processor-executable instructions (e.g., applications/programs/software) that cause the server to perform operations that fulfill the particular needs of the transaction channel 104-110 with which the server interacts. For example, a server application of an application server can issue an alert regarding a problem relative to a transaction channel with which the server is associated. One or more of the servers can also be a web server 148 that supports a data exchange with user devices associated with a given transaction channel, such as a mobile transaction channel whereby mobile user devices communicate with the entity 102 through one or more websites over the Internet.

One or more of the servers 114-120 may be configured to perform authentication, authorization, or other verification functions associated with a user or a transaction. For this and other purposes, the transaction system 100 can also include one or more data stores 122 for storing user data, account data, transaction data, etc. In any case, by way of the servers 114-120, transactions submitted by users via the transaction channels 104-110 are received, acted upon, and transferred to a downstream transaction processing layer 124 of the transaction system 100.

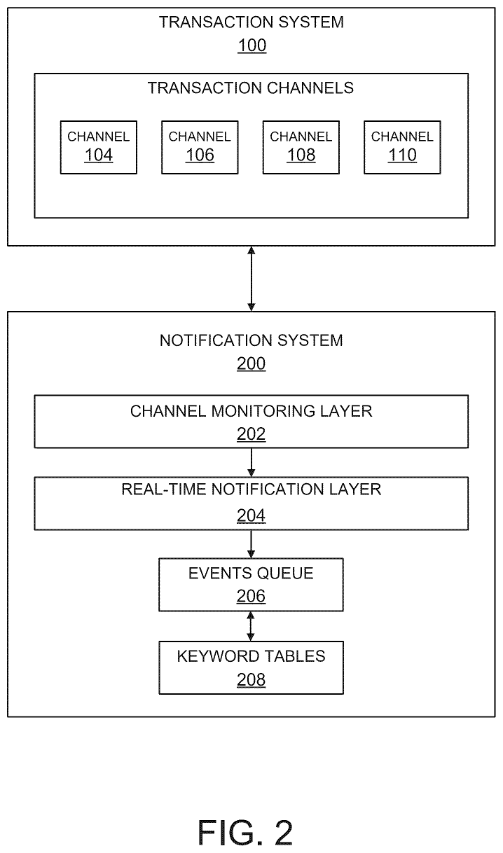

FIG. 2 is a block diagram representing one example of a notification system 200 for providing real-time notifications of problems associated with transaction channels of a transaction system, such as the transaction channels 104-110 of the transaction system 100. Each transaction channel of the plurality of transaction channels 104-110 of the transaction system 100 may be operative, through hard coding in the channel applications of the servers 114-120 or otherwise, to issue an alert whenever the channel experiences a problem.

A given alert issued relative to a transaction channel 104-110 according to some examples of the present disclosure can include an identification of the particular transaction channel of the plurality of transaction channels 104-110 that is associated with the detected problem. An alert issued relative to one of the plurality of transaction channels 104-110 may also indicate an alert type. For example, the alert can be categorized as a system type alert when, for example, the alert is related to a detected technical problem with a transaction system component such as a server, etc. Alternatively, the alert can be categorized as a data alert type when, for example, the alert is related to a detected problem with a transaction, such as a loss or corruption of transaction data. An issued alert may additionally indicate an alert severity.

The example of the notification system 200 represented in FIG. 2 includes a transaction channel monitoring layer 202 and a real-time notification layer 204. The notification system 200 is in communication with the transaction system 100, such as over a network (e.g., network 112) or otherwise, such that the transaction channel monitoring layer 202 can monitor the transaction channels 104-110 of the transaction system 100 and receive alerts therefrom. When communication between the notification system 200 and the transaction system 100 occurs over a network, the network may be without limitation, a local area network (LAN), a wide-area network (WAN) such as the Internet, an institutional network, cellular or other wireless networks, virtual networks such as an intranet or an extranet, etc., depending at least in part on the location of the notification system 200.

The transaction channel monitoring layer 202 of the notification system 200 is configured to monitor the transaction channels 104-110 and to receive an alert when there is a system or data problem associated with any of the transaction channels 104-110. An alert received by the transaction channel monitoring layer 202 of the notification system 200 relative to a transaction channel of the plurality of transaction channels 104-110 can be retrieved by the real-time notification layer 204 of the notification system 200. In one example of a notification system according to the present disclosure, the real-time notification layer 204 can retrieve the alert received by the transaction channel monitoring layer 202 directly from the transaction channel monitoring layer. In another example of a notification system according to the present disclosure, the real-time notification layer 204 can retrieve the alert received by the transaction channel monitoring layer 202 from an events queue 206 where the received alert can be temporarily stored by the transaction channel monitoring layer 202. In such an example, the real-time notification layer 204 of the notification system 200 can be communicatively coupled to the events queue 206, and is aware of each alert added to the events queue 206. Therefore, the real-time notification layer 204 can retrieve and act on alerts in the events queue 206 in real time.

Notification system 200 examples according to the present disclosure can use the information contained in an alert regarding a problem associated with a transaction channel of the plurality of transaction channels 104-110 to determine a form of a notification to be generated, the content of the notification, and at least one recipient of the notification.

Transaction system problems associated with the transaction channels 104-110 of the transaction system 100 may result in different consequences. For example, a minor system or data problem may require only that an appropriate party is made aware of the problem. Contrarily, a more serious data problem, or more likely a more serious system problem, may require a temporary shutdown of the transaction system 100 or at least the transaction channel of the plurality of transaction channels 104-110 that is associated with the problem. As such, the notification system 200 can consider the alert severity information in an alert issued by a transaction channel relative to determining a form of a notification to be generated in response to the alert.

In the case of an alert that indicates a minor system or data problem, the notification system 200 may determine that the form of a notification to be generated need only be a simple notice designed to make a recipient of the notification aware of the transaction channel problem that resulted in the alert. This type of notification may indicate that some future action is required on the part of the recipient, or may simply indicate the problem and leave any decision on resulting actions up to the discretion of the recipient. Alternatively, in the case of an alert that indicates a more serious system or data problem, such as but not limited to a system or data problem that is suggestive of or requires a shutdown of the transaction system 100, the notification system 200 may determine that the form of a notification to be generated needs to be a formal incident report or another type of warning that indicates to a recipient of the notification the severity and urgency of the transaction channel problem that resulted in the alert. This type of notification may indicate a particular action that should be taken by the recipient, or again, may leave any decision on resulting actions up to the discretion of the recipient.

When determining the content of a notification to be generated and the at least one recipient of the notification, the notification system 200 can also consider the transaction channel with which the alert is associated and the alert type information in an alert issued relative to a transaction channel. For example, if the alert type is indicative of a technical problem (i.e., the alert is a system type alert), the notification system 200 may determine that a generated notification should be transmitted to at least one recipient in the form of a person or a group of persons responsible for addressing technical problems (e.g., server or middleware problems) associated with the transaction system 100. Alternatively, if the alert type is indicative of a data problem (i.e., the alert is a data type alert), the notification system 200 may determine that a generated notification should be transmitted to at least one recipient in the form of a person or a group of persons (e.g., a channel group) associated with the operations of the particular transaction channel relative to which the alert was generated.

The content of a notification to be generated can also be determined by the notification system 200 in response to the information contained in an alert issued by a transaction channel of the plurality of transaction channels 104-110. For example, the real-time notification layer 204 of the notification system 200 may be in communication with at least one keyword data table 208. The at least one keyword data table 208 may include particular information (e.g., text) that is to be included in a generated notification when one or more keywords are found in a transaction channel alert. Therefore, the real-time notification layer can map at least some of the information contained in the alert retrieved by the real-time notification layer to a list of keywords in the at least one keyword data table, and can determine the content of the notification based at least in part on the results of the mapping.

In examples of the notification system 200 according to the present disclosure, the notification system 200 may also utilize a data table relative to determining at least one recipient of a notification to be generated. For example, when determining at least one recipient of a notification to be generated, the notification system 200 may map alert type information contained in a transaction channel alert to a data table of appropriate notification recipients based on data type, and use the mapping results in determining the at least one recipient of the notification.

Once the notification system 200 has determined a form of a notification to be generated, the content of the notification, and at least one recipient of the notification, the notification system 200 can generate the notification and transmit the notification in real-time to the at least one recipient of the notification. A generated notification may be transmitted in real time to an intended recipient in any readable or translatable format using any suitable communication mechanism known to one of skill in the art. For example, a generated notification may be transmitted to the at least one recipient through a communication channel integrated into the transaction system 100, by way of another type of institutional network, via a wide-area network (WAN) such as the Internet, or a cellular or other wireless network. In one example of a notification system 200 according to the present disclosure, a generated notification is transmitted to the at least one recipient in the form of an electronic mail message.

The operations of examples of the notification system 200 are preferably configurable rather than, for example, hard coded. In this manner, a substantially generic notification system may be developed, that may thereafter be customized or otherwise configured for operation with the particular transaction channels of a particular transaction system, as well as the particular types of alerts that can be issued relative to the transaction channels. For example, and without limitation, a unique keyword data table may be provided for each transaction channel of a transaction system, such that a real-time notification layer of the notification system can produce a notification that is specific to a given transaction channel by performing a mapping of an alert issued by the given transaction channel to a keyword data table that is unique to the given transaction channel.

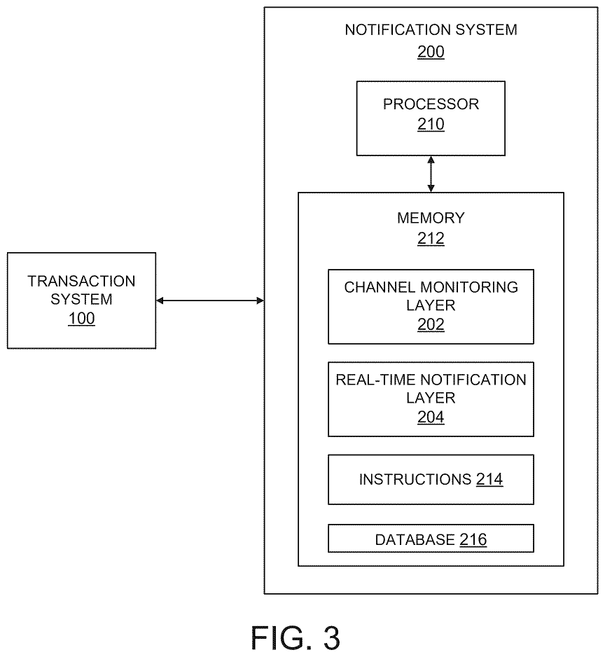

FIG. 3 is a block diagram depicting various components of one example of a notification system according to the present disclosure, such as the notification system 200 described above with respect to the block diagram of FIG. 2. As depicted, the notification system 200 may include a processor 210 that is communicatively coupled to a memory 212. The processor 210 may also be communicatively coupled to a database 216. The database 216 may store, among other things, the at least one keyword data table 208 described above with respect to FIG. 2. In some notification system examples according to the present disclosure, a database to which the processor of the notification system is communicatively coupled may be located remotely from the processor and the system memory and may be in communication with the processor over a network.

The processor 210 can include one processing device or multiple processing devices. Non-limiting examples of the processor 210 include a Field-Programmable Gate Array (FPGA), an application-specific integrated circuit (ASIC), a microprocessor, etc. The processor 210 can execute instructions 214 stored in the memory 212 to perform operations. In some examples, the instructions 214 can include processor-specific instructions generated by a compiler or an interpreter from code written in a suitable computer-programming language, such as C, C++, C #, etc.

The memory 212 can include one memory or multiple memories. The memory 212 can be non-volatile and may include any type of memory that retains stored information when powered off. Non-limiting examples of the memory 212 include electrically erasable and programmable read-only memory (EEPROM), flash memory, or any other type of non-volatile memory. At least some of the memory 212 can be a non-transitory computer-readable medium from which the processor 210 can read the instructions 214. A computer-readable medium can include electronic, optical, magnetic, or other storage devices capable of providing the processor 210 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 210 can read the instructions 214.

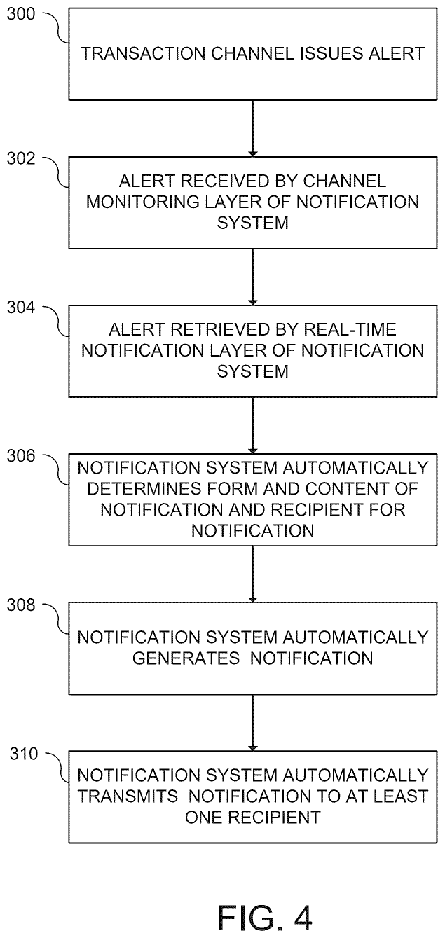

FIG. 4 is a flowchart illustrating one example of a computer-implemented method of notifying at least one recipient about an alert issued relative to a transaction channel of a transaction system. At block 300 of the flowchart of FIG. 4, a transaction channel of a plurality of transaction channels initially issues an alert regarding a problem associated with the transaction channel. At block 302, the alert issued by the transaction channel is received by a transaction channel monitoring layer of a notification system in communication with the transaction system. At block 304, the alert received by the transaction channel monitoring layer of the notification system is retrieved by a real-time notification layer of the notification system. At block 306, a processor of the notification system automatically determines, from information contained in the alert retrieved by the real-time notification layer, a form of a notification to be generated, a content of the notification, and at least one recipient of the notification. The notification system then automatically generates the notification at block 308, and subsequently automatically transmits the notification in real-time to the at least one recipient of the notification at block 310.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system, comprising:
a transaction computing system comprising:
at least one web server configured to establish a secure data exchange with remote user devices and to receive transaction requests from the remote user devices;
a plurality of application servers, each application server including a server processor and a memory communicatively coupled to the server processor, the memory storing a server application including instructions that are executable by the server processor to cause the server application to:
execute transaction requests that are received by the web server from the remote user devices via a plurality of transaction channels and subsequently forwarded to the application server, and
generate an alert when one of the plurality of transaction channels uniquely associated with the application server experiences a problem that affects operation of the transaction channel, and where the alert indicates an alert severity; and
a notification computing system communicatively coupled to the transaction computing system via a first network and comprising:
an events queue to temporarily store alerts generated by the server applications of the transaction computing system application servers;
a processor and a memory communicatively coupled to the processor, the memory including instructions that are executable by the processor to cause the notification computing system to:
monitor the transaction requests received by the transaction computing system,
receive, in real time from one or more of the server applications of the application servers of the transaction computing system, one or more alerts generated by the one or more server applications,
temporarily store the one or more alerts in the events queue,
determine, based on at least the alert severity of a given alert of the one or more alerts temporarily stored in the events queue, a need to at least partially shut down the transaction computing system,
generate a unique notification for the given alert, wherein a form of the notification is based on the alert severity, at least one recipient of the notification is determined based at least in part on the alert type, and a content of the notification informs the at least one recipient of the need to at least partially shut down the transaction computing system,
transmit the notification in real time to the at least one recipient of the notification, and
initiate at least a partial shutdown of the transaction computing system.

2. The system of claim 1, wherein at least one server of the transaction computing system is configured as at least one access server to perform authentication and authorization of users by verifying user data stored in one or more data stores, wherein the user data comprises at least one of user credentials, account data, or transaction data, and wherein the at least one access server, upon detecting a failed authentication, is further configured to generate an alert to the notification computing system for real-time notification to an appropriate party.

3. The system of claim 2, wherein the at least one access server comprises the web server configured to receive transaction requests from remote user devices and to perform authentication of the user prior to forwarding transaction requests to an application server, and wherein the application server is further configured to generate an alert in response to each of an authentication failure and a transaction processing error.

4. The system of claim 1, wherein the plurality of transaction channels comprise at least one payment channel, at least one ATM channel, at least one mobile device transaction channel, and at least one internal user access channel, wherein each transaction channel is uniquely associated with a corresponding application server configured to monitor and generate alerts based on problems specific to that channel.

5. The system of claim 1, wherein a transaction channel monitoring layer of the notification computing system is configured to receive alerts generated by server applications associated with the plurality of transaction channels, and to temporarily store each alert in the events queue, wherein each alert comprises at least an identification of the transaction channel, an alert type, and an alert severity.

6. The system of claim 1, wherein a real-time notification layer of the notification computing system is configured to retrieve alerts from the events queue, to determine, based on information in each alert, a form of notification, notification content, and at least one recipient, and to automatically generate and transmit the notification in real time to the determined recipient.

7. The system of claim 1, wherein:
an alert is categorized as a system type alert when the problem is associated with a physical or software component of the transaction computing system, and as a data type alert when the problem is associated with transaction data associated with a transaction request received by the transaction channel;
the alert includes an identification of the transaction channel for which the alert was generated;
a recipient of a notification generated for the alert is determined based on the alert type and the transaction channel for which the alert was generated by an associated server application;
the notification computing system is configured to transmit the notification to a technical problem remediation group specifically associated with the transaction channel for which the alert was generated when the alert is a system type alert; and
the notification computing system is configured to transmit the notification to a data anomaly remediation group specifically associated with the transaction channel for which the given alert was generated when the alert is a data type alert.

8. The system of claim 7, wherein the problem associated with a data type alert is a failed execution of a transaction request by an application server of the transaction computing system due to a loss or a corruption of transaction request data during transmission of the transaction request from the web server to the application server via the transaction channel associated therewith.

9. The system of claim 1, wherein the form and content of a notification for an alert generated by an application server of the transaction computing system is variable based on the alert severity, and the notification computing system is configured to escalate a formality of the notification and an urgency conveyed by the content of the notification in response to higher levels of alert severity.

10. The system of claim 1, wherein each transaction channel of the plurality of transaction channels is configured to convey a unique type of transaction request, each transaction channel is uniquely associated with a corresponding application server of the plurality of application servers, and each server application is configured to perform operations unique to the type of transaction requests received by the application server with which it is associated.

11. The system of claim 1, wherein the at least a partial shutdown of the transaction computing system is a complete shutdown of the transaction computing system.

12. The system of claim 1, wherein the transaction channel for which the given alert was generated by the server application is also identified by the given alert, and the at least a partial shutdown of the transaction computing system is a shutdown of only the identified transaction channel of the transaction computing system.

13. The system of claim 1, wherein the content of the notification includes at least some of various possible predetermined information that is selectable by mapping one or more keywords present in the alert to one or more keywords in a unique keyword data table that includes a list of keywords and corresponds to the transaction channel associated with the problem identified by the alert, and the predetermined information instructs the need to shut down the transaction computing system.

14. The system of claim 13, wherein:
each unique keyword data table includes a configurable list of keywords that are descriptive of different possible system type problems or data type problems of the transaction channel to which the keyword data table corresponds; and
the list of keywords in each of the unique keyword data tables is mapped to information to be included in the content of the notification.

15. The system of claim 1, wherein the notification computing system is configured to transmit the notification to the at least one recipient using the transaction computing system by transmitting the notification to the transaction computing system over the first network and subsequently to the at least one recipient via a communication channel integrated into the transaction computing system and associated with the transaction channel for which the given alert was generated.

16. The system of claim 1, wherein the notification computing system is configured to transmit the notification to the at least one recipient using the transaction computing system by transmitting the notification to the transaction computing system over the first network and subsequently to the at least one recipient via an institutional communication network of the transaction computing system.

17. The system of claim 1, wherein the notification computing system is configured to transmit a generated notification to the at least one recipient in the form of an electronic mail message including information selected from the alert, wherein the electronic mail message comprises an identification of the affected transaction channel, the alert type, the alert severity, and a recommended action as determined by the notification system.

18. The system of claim 1, wherein the one or more alerts is a plurality of alerts and the instructions of the notification computing system are further executable to cause the notification computing system to:
temporarily store each alert in the events queue;
determine, based on at least an alert severity of each alert, a required action in response to each alert;
generate a unique notification for each alert, wherein the recipients of the notifications are determined to be different with respect to at least some of the alerts; and
transmit the notifications to the recipients of the notifications.

19. A non-transitory computer-readable medium comprising:
a first non-transitory computer-readable medium comprising instructions that are executable by an application server processor of an application server of a plurality of application servers of a transaction computing system for causing the server processor to:
execute, by a server application of the server, transaction requests that are received by a web server through a secure data exchange with remote user devices via a plurality of transaction channels and subsequently forwarded to the application server; and
generate, by the server application, an alert when one of the plurality of transaction-channels uniquely associated with the application server experiences a problem that affects operation of the transaction channel, where the alert indicates an alert severity; and
a second non-transitory computer-readable medium comprising instructions that are executable by a processor of a notification computing system communicatively coupled to the transaction computing system via a first network and comprising an events queue to temporarily store alerts generated by the server applications of the transaction computing system application servers, the instructions configured for causing the notification computing system to:
monitor the transaction requests received by the transaction computing system;
receive, in real time from one or more of the server applications of the application servers of the transaction computing system, one or more alerts generated by the one or more server applications;
temporarily store the one or more alerts in the events queue;
determine, based on at least the alert severity of a given alert of the one or more alerts temporarily stored in the events queue, a need to at least partially shut down the transaction computing system,
generate a unique notification for the given alert, wherein a form of the notification is based on the alert severity, at least one recipient of the notification is determined based at least in part on the alert type, and a content of the notification informs the at least one recipient of the need to at least partially shut down the transaction computing system;
transmit the notification in real-time to the at least one recipient of the notification; and
initiate at least a partial shut down of the transaction computing system.

20. A computer-implemented method comprising:
at a transaction computing system comprising at least one web server configured to establish a secure data exchange with remote user devices and to receive transaction requests from the remote user devices, and a plurality of application servers, where each application server includes a server processor and a memory communicatively coupled to the server processor, the memory storing instructions that are executable by the server processor to cause the server processor to perform operations:
executing transaction requests received by the web server from the remote user devices via a plurality of transaction channels and subsequently forwarded to the application server; and
generating an alert when one of the plurality of transaction channels uniquely associated with the application server experiences a problem that affects operation of the transaction channel, where the alert indicates an alert severity; and
at a notification computing system communicatively coupled to the transaction computing system via a first network and comprising an events queue to temporarily store alerts generated by the server applications of the transaction computing system application servers, a processor, and a memory communicatively coupled to the processor and including instructions that are executable by the processor to cause the notification computing system to perform operations:
monitoring the transaction requests received by the transaction computing system,
receiving, in real time from one or more of the server applications of the application servers of the transaction computing system, one or more alerts generated by the one or more server applications,
temporarily storing the one or more alerts in the events queue,
determining, based on at least the alert severity of a given alert of the one or more alerts temporarily stored in the events queue, a need to at least partially shut down the transaction computing system,
generating a unique notification for the given alert, wherein a form of the notification is based on the alert severity, at least one recipient of the notification is determined based at least in part on the alert type, and a content of the notification informs the at least one recipient of the need to at least partially shut down the transaction computing system,
transmitting the notification in real time to the at least one recipient of the notification; and
initiating at least a partial shutdown of the transaction computing system.
